(19) United States
(12) Patent Application Publication
(10) Pub. No.: US 2006/0045093 A1
(43) Pub. Date: Mar. 2, 2006

(54) Apparatus and method for controlling scheduling in mobile communication system

(75) Inventor: Jeong-Hoon Choi, Gyeonggi-Do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/217,226

(22) Filed: Sep. 1, 2005

(30) Foreign Application Priority Data
Sep. 2, 2004 (KR) 2004/0070091

(51) Int. Cl. H04L 12/56; H04L 12/54

(52) U.S. Cl. 370/395.4; 370/428; 370/412

(57) ABSTRACT

A scheduling apparatus and method are capable of maximizing efficiency of trunk line usage and preventing queue congestion when a trunk line is used in a mobile communication system. A variable bandwidth management service for allocating more bandwidth to a queue with greater traffic is provided so that allocation of bandwidth can be made flexibly. A scheduler calculates actually provided class information and performs scheduling according to a current scheduling ratio, thereby preventing congestion of a specific queue.

### CROSS-REFERENCE TO RELATED APPLICATIONS

Pursuant to 35 U.S.C. § 119(a), this application claims the benefit of earlier filing date and right of priority to Korean Application No. 70091/2004 filed Sep. 2, 2004, the contents of which are hereby incorporated by reference herein in its entirety.

### FIELD OF THE INVENTION

The present invention relates to a mobile communication system and, more particularly, to an apparatus and method for controlling scheduling capable of maximizing efficiency of trunk line usage and preventing congestion at a queue for using various multimedia services in the mobile communication system.

### BACKGROUND OF THE INVENTION

In line with development of mobile communication techniques and generalization of mobile communication terminals, a mobile communication system is not limited to providing a simple voice call communication service but extends to providing various multimedia data services such as music, video or television or radio broadcast.

Accordingly, the mobile communication techniques focus on how much data can be transmitted quickly and effectively. When a new or enhanced service is provided, efficiency of data transmission becomes important because the new or enhanced service is operated on the existing mobile communication system.

Currently, in a recent mobile communication system in which both a data and a voice are simultaneously provided, a method for maximizing usage efficiency of a trunk line such as E1 link or T1 link has been studied.

In a related art, the scheduling of the processing for a trunk line, transmission of traffic is allocated a fixed bandwidth according to a fixed scheduling ratio. Thus, while bandwidth is allocated according to a scheduling ratio received first from a control plane between voice and data, if the service type of subscribers is subsequently changed so that the ratio between the actually transmitted voice and the data is changed, the efficiency of the trunk line is degraded and queue congestion occurs.

The control plane is used as a resource management concept in a radio interface of the mobile communication system, and configuration of a protocol can be divided into the control plane and a traffic plane. The control plane relates to the control signals while the traffic (data) plane relates to the data or voice traffic. Thus, in order to transmit actual traffic, the control plane is required, and the discrimination of the planes effectively manages the various type of traffic.

For example, if the amount of the voice traffic is increased while the amount of the data traffic is decreased compared with the fixed scheduling ratio, voice queue becomes congested. Because the scheduler allocated much of the bandwidth to data traffic, significant bandwidth is wasted, resulting in degradation of efficiency of the trunk line usage. Also, in order to receive a relocated scheduling ratio from the control plane, the scheduler operating at the fixed scheduling ratio must be initialized.

### SUMMARY OF THE INVENTION

Therefore, one object of the present invention is to provide an apparatus and method for controlling scheduling in a mobile communication system capable of maximizing efficiency of trunk line usage.

Another object of the present invention is to provide an apparatus and method for controlling scheduling in a mobile communication system capable of preventing queue congestion.

To achieve at least the above objects in whole or in parts, an apparatus is provided for controlling scheduling in a mobile communication system, including: a classifying unit for receiving traffic with various class types to be transmitted through a trunk line and classifying the received classes; a forwarding unit for receiving the classified traffic data together with class information and writing traffic in a corresponding voice or data queue by using the received class information; a buffering unit for storing information transferred from the forwarding unit; a scheduler for allocating a band within a trunk line bandwidth range of each voice or data queue, performs scheduling, reading traffic from each voice and data queue, and placing the voice and data traffic on the trunk line; and a changing unit for calculating a bandwidth of each class actually scheduled by the scheduler for a certain time to determine a suitable scheduling ratio, and varying the scheduling ratio.

Preferably, the scheduling unit regards the voice and data queues in a buffering unit as one virtual integrated queue and manages both queues with a variable bandwidth for a flexible allocation.

Preferably, the changing unit stores the class type actually scheduled by the scheduling unit in a storage unit during a certain time, calculating a scheduling ratio of each class by analyzing the class type, and changing a current scheduling ratio to a calculated scheduling ratio.

To achieve at least these advantages in whole or in parts, there is further provided a method for controlling scheduling in a mobile communication system, including: classifying introduced traffic of various class types; transmitting traffic together with class information; storing traffic in a corresponding voice or data queue; monitoring the voice and data queues; sensing a non-empty state of the voice or data queue and determining whether the voice or data queue is actually in the non-empty state; and performing variable scheduling by allocating a corresponding bandwidth to the non-empty queue.

Preferably, the method for controlling scheduling in the mobile communication further includes performing scheduling according to a scheduling ratio received from a control plane during initialization if the voice or data queue is actually in the non-empty state.

To achieve at least these advantages in whole or in parts, there is further provided a mobile communication system including: a mobile station (MS) allowing a subscriber to communicate by using a mobile communication network in a service area; a base station transceiver subsystem (BTS) connected with the MS by a radio interface, controlling the MS and connecting a traffic channel; a base station controller (BSC) having a scheduling controller which is provided at an end thereof, manages introduced traffic with a variable bandwidth and schedules the traffic according to an actual traffic transmission situation, transmitting traffic to the BTS through a trunk line such as an E1 link or a T1 link according to a scheduling result, and handling controlling and management of the BTS; a mobile switching center (MSC) performing functions such as circuit switching, incoming/outgoing processing, handoff, roaming, or the like in order to provide a mobile communication service to a mobile communication subscriber; and a base station manager (BSM) for operating/managing and maintenance of the entire BTS, and performing loading for initialization.

Preferably, when the BSC receives voice or data traffic introduced from an MS of a different area or a network and transmits it to the MS through the BTS, the BSC includes the traffic in the trunk line according to a scheduling ratio determined by the scheduling controller. The scheduling ratio is received from a control plane during initialization, and the ratio may be changed later by the scheduling controller according to a ratio between the actual voice and data traffic.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the construction of a mobile communication system having a scheduling controller in accordance with the present invention;

FIG. 2 illustrates the construction of the scheduling controller of a trunk line in the mobile communication system in accordance with the present invention;

FIG. 3 is a flow chart of a method for controlling scheduling of the trunk line in the mobile communication system in accordance with one embodiment of the present invention; and

FIG. 4 is a flow chart of a method for controlling scheduling of the trunk line in the mobile communication system in accordance with another embodiment of the present invention

### DETAILED DESCRIPTION OF THE INVENTION

The embodiments of the present invention will now be described with reference to the accompanying drawings. In describing the present invention, if a detailed explanation for a related known function or construction is considered to unnecessarily divert the intent of the present invention, such explanation has been omitted but would be understood by those skilled in the art.

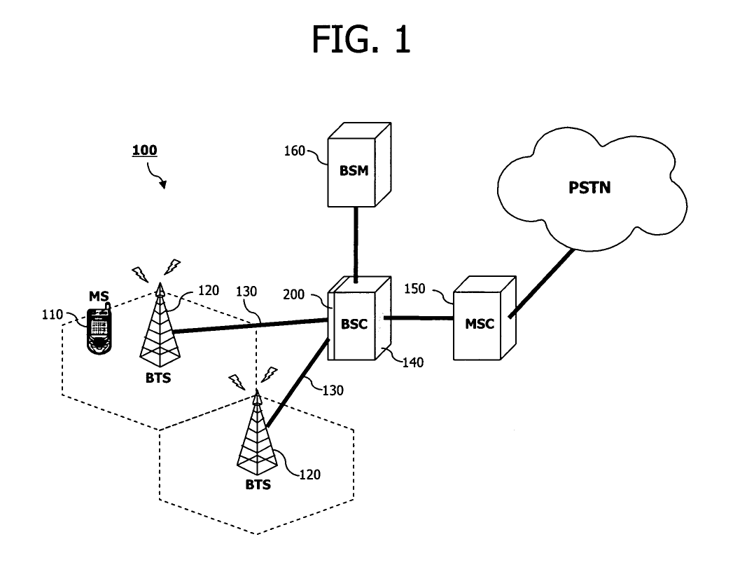

FIG. 1 illustrates the construction of a mobile communication system having a scheduling controller in accordance with the present invention, wherein the mobile communication system 100 having the scheduling controller includes a mobile station (MS) 110 allowing a subscriber to communicate by using a mobile communication network in a service area; a base station transceiver subsystem (BTS) 120 connected with the MS 110 by a radio interface, controlling the MS 110 and connecting to a traffic channel; a base station controller (BSC) 140 having a scheduling controller for scheduling introduced traffic for and transmitting traffic according to a scheduling ratio to the BTS 120 through a trunk line 130 such as an E1 link or a T1 link, and controlling and managing the BTS 120; a mobile switching center (MSC) 150 performing functions such as circuit switching, incoming/outgoing processing, handoff, roaming, or the like in order to provide a mobile communication service to a mobile communication subscriber; and a base station manager (BSM) 160 for operating/managing and maintaining/repairing the BTS 120, and performing loading for initialization.

When the BSC 140 receives voice or data traffic introduced from a mobile station located in a different area or network, and transmits the traffic to the MS 110 through the BTS 120, The BSC 140 includes the traffic in the trunk line 130 according to a scheduling ratio determined by the scheduling controller 200. The scheduling ratio is received first from a control plane and can be changed later by the scheduling controller according to a ratio between a voice and data traffic actually received.

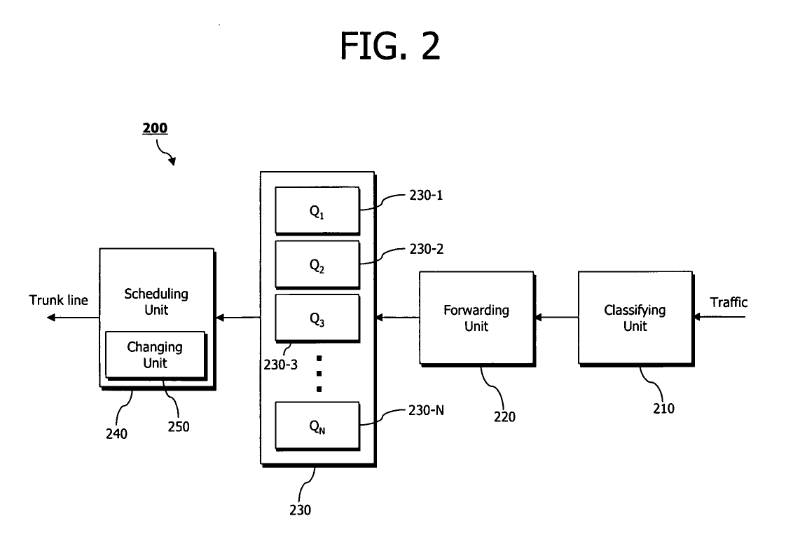

FIG. 2 illustrates the construction of the scheduling controller of a trunk line in the mobile communication system in accordance with the present invention, wherein the scheduling controller 200 of the trunk line includes a classifying unit 210 for classifying a class of introduced traffic; a forwarding unit 220 for writing class information in a corresponding voice or data queue; a buffering unit 230 for storing information transferred from the forwarding unit 220; a scheduling unit 240 for performing scheduling to allocate a bandwidth to the voice or data queue according to a scheduling ratio received from the control plane during initialization, and reading traffic from the voice and data queues and including it in the trunk line; and a changing unit 250 for storing a class type scheduled by the scheduling unit 240 for a certain time, determining a suitable scheduling ratio, and varying the current scheduling ratio.

The classifying unit 210 receives traffic having various class types to be transmitted to the trunk line and classifies the traffic according to whether the traffic is voice or data. The classifying unit 210 provides traffic and corresponding class information to the forwarding unit 220.

The forwarding unit 220 determines whether to write the corresponding traffic in a voice queue or in a data queue responsive to the class information provided from the classifying unit 210, and writes the traffic in a corresponding queue.

The buffering unit 230 includes a plurality of integrated queues, 230-1 to 230-N, each integrated queue comprising a voice queue and a data queue, for storing the traffic forwarded from the forwarding unit 220 according to whether the traffic is voice or data. The voice and data queues are regarded as one virtual integrated queue and managed by the scheduling unit 240. Accordingly, the N number of queues of Q1˜QN 230-1 to 230-N are managed as the N/2 number of virtual integrated queues. Information forwarded from the forwarding unit 220 is classified as voice traffic or data traffic and stored in a corresponding queue.

The scheduling unit 240 regards the voice and data queues of the buffering unit 230 as one virtual integrated queue with a variable bandwidth according to the scheduling ratio received from the control plane during initialization. Though not shown, schedulers corresponding to the number of integrated queues are provided in the scheduling unit 240 and the schedulers monitor the integrated queues in real time. When the integrated queue informs the scheduler that one of the two queues is not in an empty state with stored traffic, the scheduler checks whether the other queue is actually not in the empty state, and if the non-empty state is confirmed, the scheduler performs scheduling according to the scheduling ratio. Meanwhile, if the other queue is in an empty state, the scheduler determines that a non-empty state of the other remaining queue makes the virtual integrated queue non-empty state and allocates corresponding bandwidth to the other remaining queue. In addition, the scheduler reads traffic from each voice and data queue and includes the traffic in the trunk line.

The changing unit 250 stores the actually scheduled class type in the storage unit for a certain time, analyzes it to calculate a scheduling ratio of each class, and changes the current scheduling ratio of the scheduling unit 240 to the calculated scheduling ratio. In this case, the calculated scheduling ratio can be directly applied to the scheduling unit 240 or information on whether to change the scheduling ratio is provided to an upper operator such as the BSM 160.

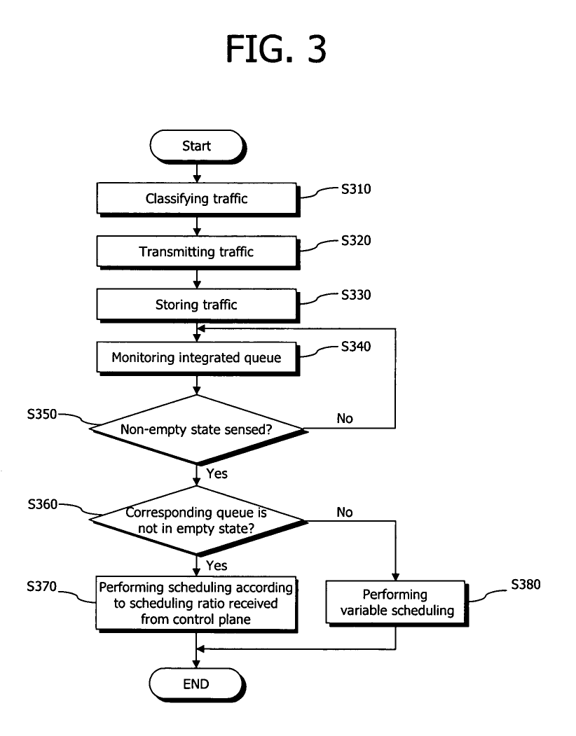

FIG. 3 is a flow chart of a method for controlling scheduling of the trunk line in the mobile communication system in accordance with one embodiment of the present invention.

With reference to FIG. 3, the classifying unit 210 generates class information by discriminating whether introduced traffic is a voice signal or a data signal, and transmits the generated class information together with traffic to the forwarding unit 220 (step S310). Upon receiving the class information from the classifying unit 210, the forwarding unit 220 determines whether to write the corresponding traffic in the voice queue or in the data queue by referencing the generated class information, writes the traffic into the voice or data queue, and transmits the traffic (step S320). Upon receiving the traffic from the forwarding unit 220, the buffering unit 230 stores the received traffic in a voice or data queue (step S330). The scheduling unit 240 regards the voice and data queues as one virtual integrated queue and monitors the virtual integrated queue (step S340). When one of the integrated queue is sensed to be in non-empty state during monitoring (step S350), the scheduling unit 240 determines whether the other queue is actually in the empty state or not (step S360). If the other queue is not in the empty state, the scheduling unit 240 performs scheduling according to the scheduling ratio initially received from the control plane (step S370). However, if the other queue is in an empty state, the scheduling unit 240 performs variable scheduling for allocating a corresponding bandwidth to the non-empty queue (step S380).

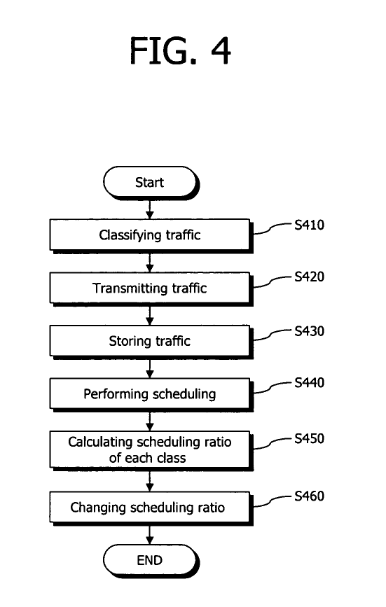

FIG. 4 is a flow chart of a method for controlling scheduling of the trunk line in the mobile communication system in accordance with another embodiment of the present invention.

As shown in FIG. 4, the classifying unit 210 discriminates whether introduced traffic is a voice signal or a data signal, generates class information, and transmits the generated class information together with traffic to the forwarding unit 220 (step S410). Upon receiving the class information from the classifying unit 210, the forwarding unit 220 determines whether to write the corresponding traffic in the voice queue or in the data queue with reference to the received class information, writes it in the voice or data queue, and forward the traffic (step S420). Upon receiving the traffic from the forwarding unit 220, the buffering unit 230 stores the received traffic in a voice or data queue (step S430). The scheduling unit 240 performs scheduling according to the scheduling ratio initially received from the control plane (step S440). The changing unit stores the class type actually scheduled by the scheduler in the storage unit for a certain time, analyzing it to calculate a scheduling ratio of each class (step S450), and changes the current scheduling ratio of the scheduler to the calculated scheduling ratio (step S460). In this case, the calculated scheduling ratio can be directly applied to the scheduler, or information on whether to change the calculated scheduling ratio is provided to an operator such as the BSM, so that the operator can change the scheduling ratio of the scheduler.

As so far described, the apparatus and method for controlling scheduling in the mobile communication system have many advantages. For example, bandwidth may be flexibly allocated between voice and data traffic when one of the data or voice queues is in a non-empty state. Instead of using a fixed bandwidth allocation ratio, the bandwidth ratio allocated to voice and data traffic may be varied according to the traffic. If trunk line occupancy rate is high due to traffic, there is a possibility of congestion in each queue, therefore the scheduler calculates actual class information to determine an optimum scheduling ratio, thereby preventing congestion of the corresponding queue.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for controlling scheduling in a mobile communication system, the apparatus comprising:
a classifying unit for receiving traffic data of various class types to be transmitted through a trunk line and for determining class information of the received traffic data;
a forwarding unit for receiving the traffic data and the class information;
a buffering unit further comprising a plurality of integrated data queues for storing the traffic data and the class information received from the forwarding unit, wherein each of the plurality of integrated data queues comprises a first queue and a second queue;
a scheduling unit for allocating the bandwidth of the trunk line for each of the first and second queues of the plurality of integrated data queues according to a received scheduling ratio; and
a changing unit for calculating the bandwidth for each class actually scheduled by the scheduling unit for a certain period of time to calculate a current scheduling ratio, and modifying the received scheduling ratio.

2. The apparatus of claim 1, wherein the classifying unit provides the traffic data and class information to the forwarding unit.

3. The apparatus of claim 2, wherein the traffic data is classified as voice traffic or data traffic.

4. The apparatus of claim 1, wherein the forwarding unit writes the received traffic into one of the first queues or into a one of the second queues responsive to the class information.

5. The apparatus of claim 1, wherein the scheduling unit schedules the retransmission of traffic data to the trunk line responsive to the received scheduling ratio, wherein the received scheduling ratio is received from a base station manger.

6. The apparatus of claim 5, wherein the scheduling unit includes a plurality of schedulers corresponding to the plurality of integrated data queues.

7. The apparatus of claim 6, wherein each of the plurality of schedulers monitors the corresponding integrated data queue in real time, wherein each of the plurality of integrated data queues informs the corresponding scheduler whether the first queue or the second queue is in a non-empty state, and wherein each of the plurality of schedulers verifies the corresponding first queue or second queue is actually in the non-empty state.

8. The apparatus of claim 7, wherein the scheduling unit schedules the bandwidth of the trunk line according to the received scheduling ratio when the corresponding integrated data queue is not empty.

9. The apparatus of claim 7, wherein if the corresponding first or second queue is actually in an empty state, each scheduler allocates trunk line bandwidth to the other remaining queue of the corresponding integrated queue.

10. The apparatus of claim 1, wherein the changing unit stores the class information of the traffic data actually scheduled during a period of time, calculates the current ratio of each class of traffic by analyzing the class information, and updates the received scheduling ratio according to the current ratio.

11. The apparatus of claim 10, wherein the changing unit replaces the received scheduling ration with the current scheduling ratio.

12. The apparatus of claim 10, wherein the changing unit provides the current ratio to the base station manager thereby enabling the base station manager to modify the received scheduling ratio.

13. A method for controlling scheduling in a mobile communication system, the method comprising the steps of:
receiving a scheduling ratio;
classifying received traffic data into various class types and determining class information of the received traffic data;
transmitting traffic data and class information;
storing traffic data in a plurality of integrated queues, wherein each of the integrated data queues comprises a first queue and a second queue;
allocating trunk line bandwidth responsive to the scheduling ratio.

14. The method of claim 13, wherein the traffic data is classified as voice traffic or data traffic.

15. The method of claim 14 further comprising writing the traffic data to the first queue of one of the plurality of integrated queues when the traffic data is classified as data traffic.

16. The method of claim 14 further comprising writing the traffic data to the second queue of one of the plurality of integrated queues when the traffic data is classified as voice traffic.

17. The method of claim 13 further comprising:
monitoring each of the plurality of integrated data queues;
sensing a non-empty state of one of the first or second queues of one of the plurality of integrated data queues and determining whether the first or second queue is actually in the non-empty state; and
changing the scheduling ratio responsive to an actual ratio of class information of the received traffic data when either the first queue or the second queue of one of the plurality of integrated queues is not empty.
